(19) United States
(12) Patent Application Publication
(10) Pub. No.: US 2024/0372626 A1
(43) Pub. Date: Nov. 7, 2024

(54) Method of Improving Extinction Ratio And Bandwidth of Optical Multiplexers/Demultiplexers

(71) Applicant: II-VI Delaware, Inc., Wilmington, DE (US)

(72) Inventors: Argishti Melikyan, Wilmington, DE (US); Po Dong, Wilmington, DE (US)

(21) Appl. No.: 18/143,138

(22) Filed: May 4, 2023

(51) Int. Cl. H04B 10/548; H04B 10/67

(52) U.S. Cl. CPC H04B 10/548; H04B 10/675

(57) ABSTRACT

An optical frequency-division demultiplexer, with a plurality of cascaded half-band filters, each of which comprises a plurality of stages. At least a first half-band filter and a second half-band filter have different orders but the same channel spacing.

### TECHNICAL FIELD

The present disclosure generally relates to improving extinction ratio and bandwidth of optical multiplexers/demultiplexers.

### BACKGROUND

Aspects of the present disclosure relate to improving extinction ratio and bandwidth of optical demultiplexers. Various issues may exist with conventional solutions for improving extinction ratio and bandwidth of optical multiplexer/demultiplexers. In this regard, conventional systems and methods for improving extinction ratio and bandwidth of optical demultiplexers may be costly, cumbersome, and/or inefficient.

Limitations and disadvantages of conventional systems and methods will become apparent to one of skill in the art, through comparison of such approaches with some aspects of the present methods and systems set forth in the remainder of this disclosure with reference to the drawings.

### BRIEF SUMMARY OF THE DISCLOSURE

Shown in and/or described in connection with at least one of the figures, and set forth more completely in the claims are methods for improving extinction ratio and bandwidth of optical multiplexer/demultiplexers.

These and other advantages, aspects and novel features of the present disclosure, as well as details of illustrated embodiments thereof, will be more fully understood from the following description and drawings.

### BRIEF DESCRIPTION OF THE DRAWINGS

The various features and advantages of the present disclosure may be more readily understood with reference to the following detailed description taken in conjunction with the accompanying drawings, wherein like reference numerals designate like structural elements.

FIG. 1 illustrates part of an exemplary CDWM system.

FIG. 2 illustrates an exemplary half-band optical filter based on two-port lattice-form optical delay-line circuit.

FIG. 3 illustrates an exemplary demultiplexer for a frequency-division multiplexing system.

FIG. 4A illustrates exemplary transmission spectra of two optical half-band filter.

FIG. 4B illustrates exemplary transmission spectra of an exemplary half-band filter.

### DESCRIPTION

The following discussion provides various examples of semiconductor devices and methods of manufacturing semiconductor devices. Such examples are non-limiting, and the scope of the appended claims should not be limited to the particular examples disclosed. In the following discussion, the terms “example” and “e.g.,” are non-limiting.

The figures illustrate the general manner of construction, and descriptions and details of well-known features and techniques may be omitted to avoid unnecessarily obscuring the present disclosure. In addition, elements in the drawing figures are not necessarily drawn to scale. For example, the dimensions of some of the elements in the figures may be exaggerated relative to other elements to help improve understanding of the examples discussed in the present disclosure. The same reference numerals in different figures denote the same elements.

The term “or” means any one or more of the items in the list joined by “or”. As an example, “x or y” means any element of the three-element set {(x), (y), (x, y)}. As another example, “x, y, or z” means any element of the seven-element set {(x), (y), (z), (x, y), (x, z), (y, z), (x, y, z)}.

The terms “comprises,” “comprising,” “includes,” and/or “including,” are “open ended” terms and specify the presence of stated features, but do not preclude the presence or addition of one or more other features.

The terms “first,” “second,” etc. may be used herein to describe various elements, and these elements should not be limited by these terms. These terms are only used to distinguish one element from another. Thus, for example, a first element discussed in this disclosure could be termed a second element without departing from the teachings of the present disclosure.

Unless specified otherwise, the term “coupled” may be used to describe two elements directly contacting each other or describe two elements indirectly connected by one or more other elements. For example, if element A is coupled to element B, then element A can be directly contacting element B or indirectly connected to element B by an intervening element C. Similarly, the terms “over” or “on” may be used to describe two elements directly contacting each other or describe two elements indirectly connected by one or more other elements.

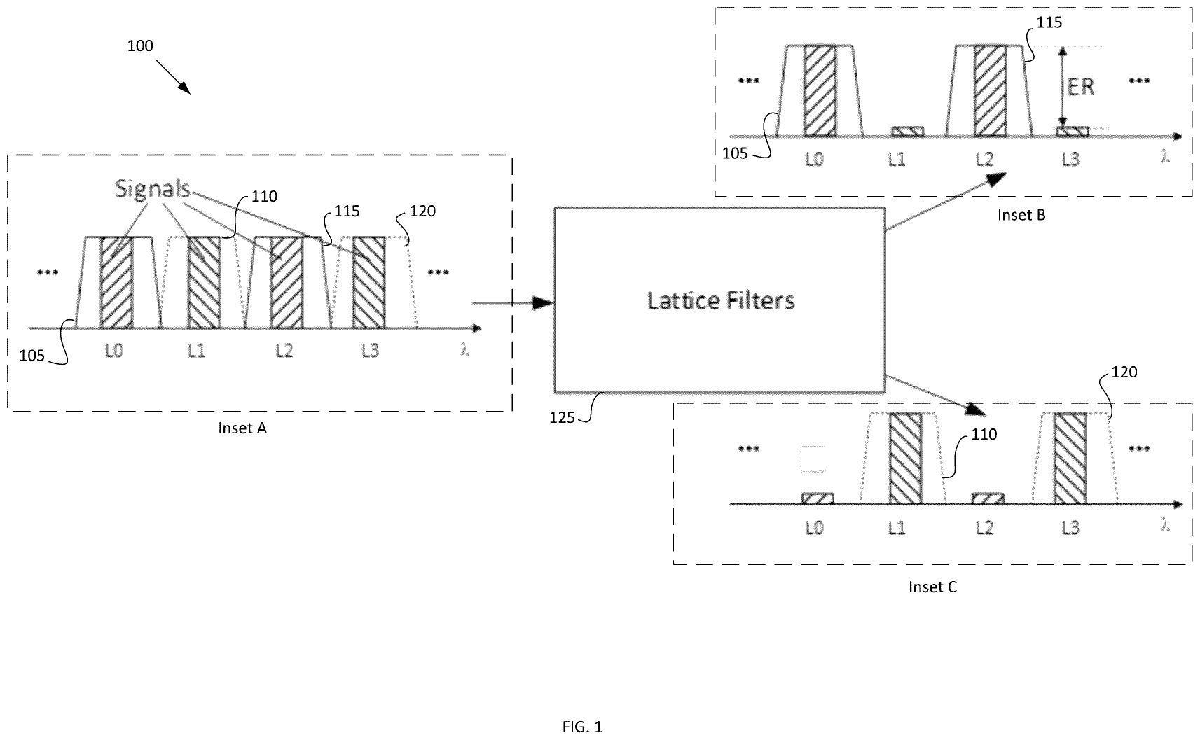

Referring now to FIG. 1, FIG. 1 shows a CWDM channel separation system 100. There is shown a first frequency band 105 with associated signal carrier frequency L0, a second frequency bands 110 with associated signal carrier frequency of L1, a third frequency band 115 with associated signal carrier frequency of L2, and a fourth signal band 120 with associated signal carrier frequency of L3. There is further shown a lattice filter 125. There is further shown an inset A, showing the input spectrum to the lattice filter 125, and inset B showing a first output spectrum of the lattice filter 125 and an inset C showing a second output spectrum of the lattice filter 125.

To meet ever-increasing bandwidth demand in optical communications, wavelength-multiplexed transmission may be a key technology.

For example, coarse wavelength division multiplexing (CWDM, sometimes referred to in terms of similar industry standards) may use 20 nm channel spacing, as illustrated by frequency bands 105, 110, 115, 120 in FIG. 1. The passband bandwidth of the filters around the carrier frequencies of L0, L1, L2, and L3 may be larger than, or equal to, 13 nm in some cases. The modulated signal spectrum may be illustrated hashed in Inset A, B, and C, for example.

When multiple information-bearing signals using different frequencies may simultaneously be present in a single transmission medium like an optical fiber, it may be important to be able to separate the different signal channels, e.g., L0, L1, L2, and L3. Such a system may be a form of frequency division multiplexed system. For example, at a receiver, it may be advantageous to separate L0 from L1 (and from L2 and L3, spaced further apart), for example. As will be understood by the person skilled in the art, separating neighboring signal bands may be more difficult, as they may be more prone to interfere with each other.

To separate channels with different (center) wavelengths, an extinction ratio of >20 dB across a passband bandwidth 14 to 15 nm in CWDM applications may be desirable to accommodate for variations in fabrication tolerances and temperature. For example, a carrier frequency L1 may be slightly offset from its desired center frequency location.

A lattice filter 125 may be operable as an optical half-band filter to separate bands as illustrated in inset B and inset C. As will be clear to a person skilled in the art, an optical half-band filter may be implemented using other designs than a lattice filter and thus lattice filter shall not be construed to be limiting. A lattice filter 125 may comprise an optical half-band filter comprising one or more lattice filters, which may comprise further components enabling frequency division demultiplexing. Inset B shows that signals at L0 and L2 may be preserved on a first output, whereas inset C shows that on a second output signals at L1 and L3 may be preserved. As shown for inset B, for example, bands L1 and L3 may be largely suppressed as illustrated by the extinction ratio “ER.”

As will be clear to a person skilled in the art, half-band filters may also be synthesized from delay-line circuits with ring resonators, which may be infinite impulse response (IIR) digital filters.

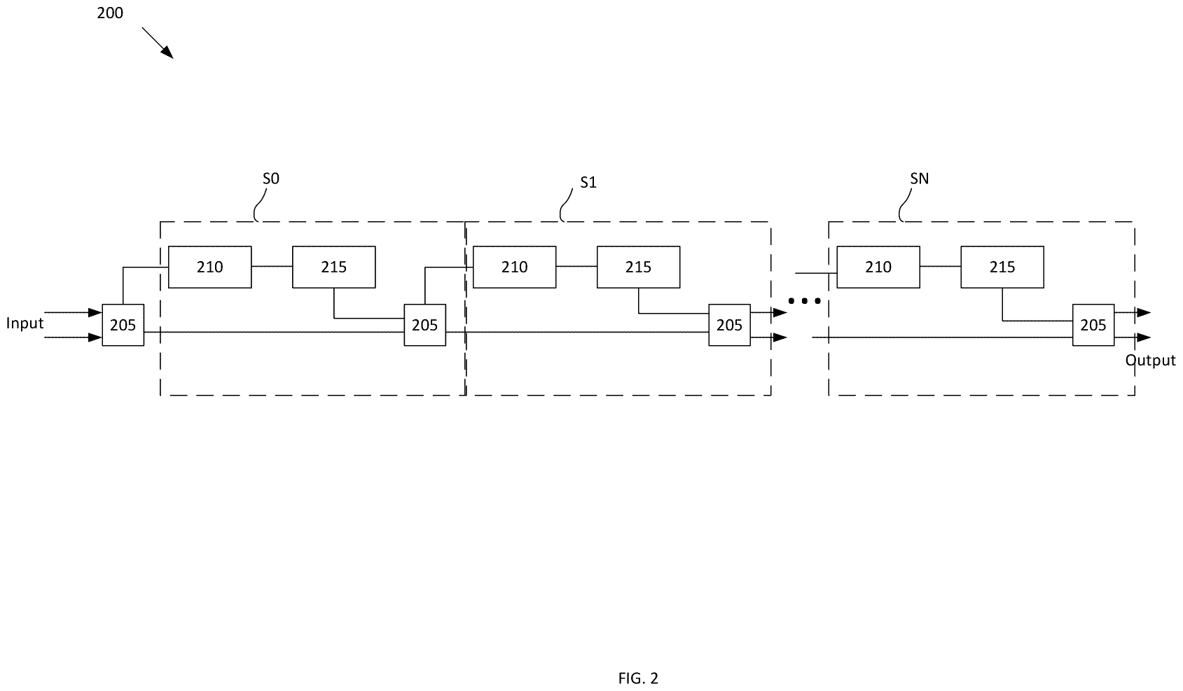

FIG. 2 may illustrate a two-port lattice-form optical delay-line circuit 200. There is shown a two-port input and a two-port output. In some embodiments, a single-port input may be desirable. The circuit 200 may comprise couplers 205, waveguides 210, and phase shifters 215. The structure illustrated may be repetitive and may comprise N+1 stages, each comprising a coupler 205, a waveguide 210, and a phase shifter 215, labeled by exemplary S0, S1, and SN.

The waveguides 210 may introduce a same delay between their respective inputs and outputs. The waveguides 210 may comprise a path length, that may be obtained with any suitable structure or component that may enable an optical delay. Such a structure may be a length of fiber, a free-space delay line, integrated photonic waveguides, plasmonic waveguides etc. The phase shifters 215 may each introduce a phase shift P (k), where k may denote the stage Sk. The phase shifters 215 may induce a fixed phase shift by incremental optical path length imbalance between the arms of the delay stage Sk, or actively controlled (variable) phase shifters based on e.g. thermos-optic, plasma-dispersion effect, magneto-optic effect, electro-optic Pockels effect, Kerr-effect etc. The couplers 205 may be directional couplers with an amplitude coefficient of sin a(k), where k may denote the stage Sk. The couplers 205 may be prism, grating, or waveguide couplers. Couplers 205 may be operable to combine input signals, for example by enabling a weighted sum of input signals at an output. In accordance with various embodiments of the patent, the phase shifter 215, waveguide 210 and/or couplers 205 may be functionally obtained from components that may combine some or all of the functionality of these. For example, a coherent optical delay-line circuit with phase shifters may be fabricated using planar lightwave circuits. This lattice structure shown in FIG. 2 may also be described as an optical half-band filter, a FIR filter with complex expansion coefficients, as illustrated e.g., by Jinguji/Kawachi, “Synthesis of Coherent Two-Port Lattice-Form Optical Delay-Line Circuit”, IEEE Journal of Lightwave Technology, Vol. 13, No. 1, January 1995. By suitably selecting the waveguide 210 delays, the coupling coefficient angles a(k) and the phase shift values P(k), a desirable FIR filter with complex expansion coefficients may be obtained. An M-th order FIR filter may be obtained by cascading stages S0, . . . , SN as illustrated in FIG. 2. For example, such an FIR filter may be operable as a multi-channel selector to enable multiplexing/demultiplexing in frequency-division multiplexing systems.

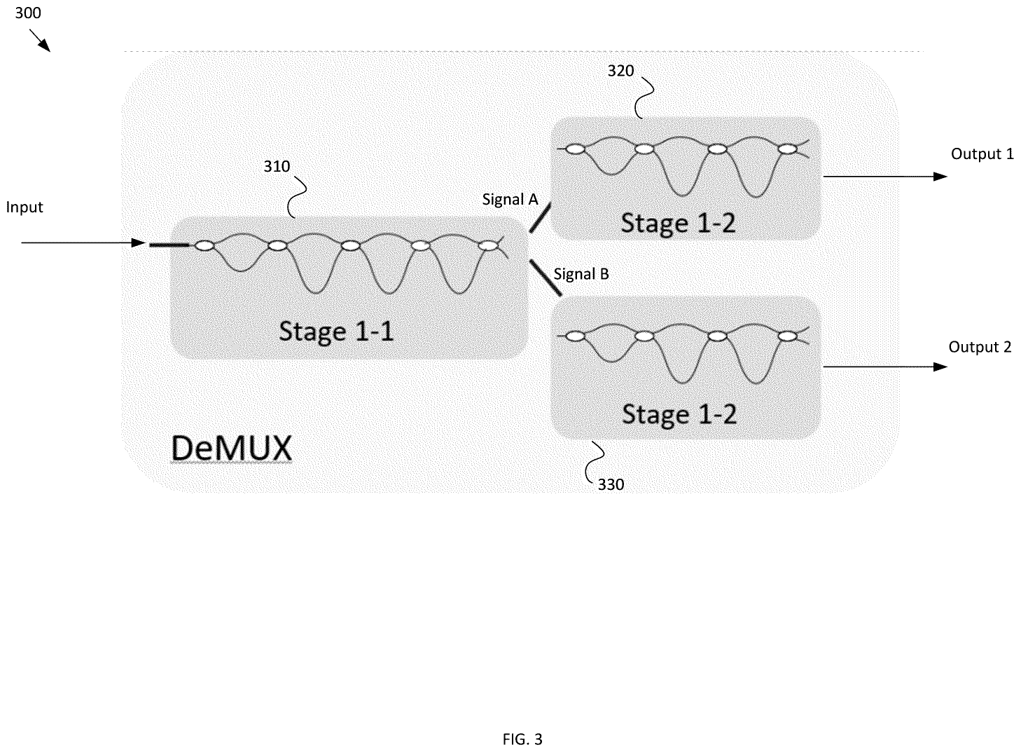

FIG. 3 illustrates an exemplary multi-stage lattice filter system. There is shown lattice filters 310, 320, and 330. There is further shown an input signal, an output 1 signal and an output 2 signal. Signal A denotes the output signal of lattice filter 310 into filter 320, signal B denotes the output signal of lattice filter 310 into lattice filter 330. The lattice filters 310, 320 and 330 may be two-port lattice-form optical delay-line circuits 200 as illustrated in FIG. 2. Filter 310 may be of order N and filters 320, 330 may be of order M, such that N≠M and the difference between N and M may be an even number. The filters 310, 320, 330 may have identical channel spacing.

FIG. 3 may illustrate a CDWM demultiplexer filter, operable to separate even and odd frequency channels, i.e., similar to lattice filters 125 illustrated in FIG. 1, separating L0 and L2 from L1 and L3. Because the channel spacing of the filters 310, 320, and 330 may be identical, an exemplary channel spacing (spacing of the passbands) may be 40 nm (e.g., between L0 and L2) for a 20 nm spacing between neighboring channels (e.g., L0 and L1), as described for FIG. 1.

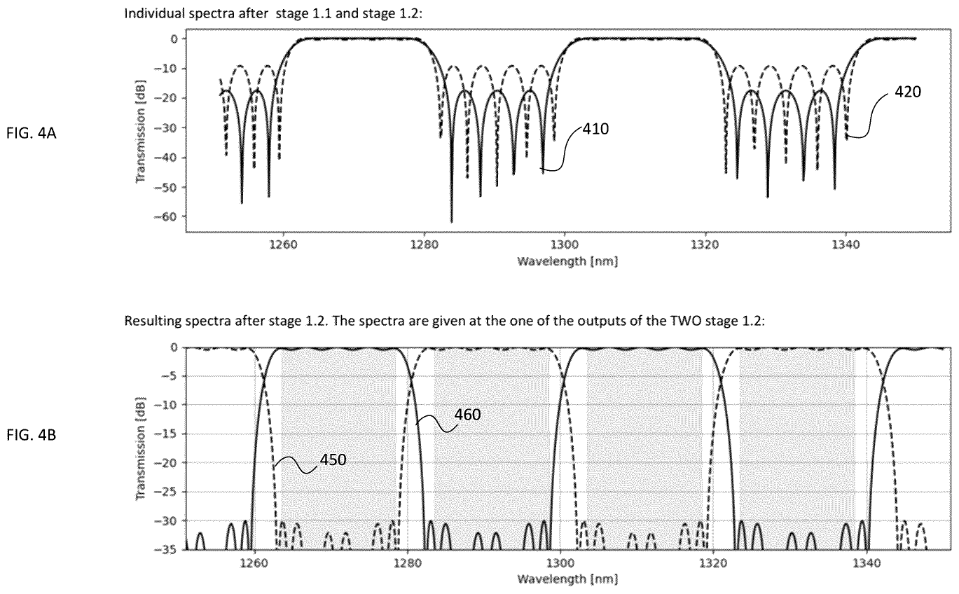

FIG. 4A illustrates exemplary spectra of a CDWM demultiplexer 300. FIG. 4A on the x-axis shows wavelength in nanometers, and (power) transmission in dB on the y-axis, respective to an input signal power. The solid line 410 may correspond to the filter spectra of lattice filter 320 (stage 1-2). The dashed line 420 may correspond to the filter spectrum of lattice filter 310 (stage 1-1).

As illustrated, both filters 310, 320 may exhibit passbands centered at about 1270 nm, which may correspond to L0 (as illustrated in FIG. 1), and 1310 nm, which may correspond to L2. The filters 310, 320 attenuate the signals between the passbands. Because filter 310 has order N and filters 320, 330 may have a different order M (and thus may have a different number of stages), the minima and maxima in the spectral transmission are different. For example, as illustrated in FIG. 3, the lattice filter 310 may be of a higher order than the lattice filters 320, 330, i.e., N>M, with the difference between N and M an even number.

Because the FIR filters 310 and 320 have different order and the difference in order is even, the respective minima and maxima are different, as may be seen by comparing minima and maxima peaks in the stop band, e.g., between about 1280 nm and about 1300 nm, or between about 1320 nm and 1340 nm. In the illustrated example, the spectrum 420 may be of order N=M+2, where M may be the filter order associated with spectrum 410. By suitably choosing the filter order N and M, and suitably placing the minima and the maxima in the stopband of each filter, the minima of spectrum 410 e.g. may approximately coincide with the maxima of the spectrum 420, which may result in an improved stopband attenuation of the cascaded filters 310 and 320 over either filter alone. In the illustrated example, spectrum 420 (stage 1-1) may show a narrower passband but a lesser attenuation in the stopband, while the spectrum 410 (stage 1-2) may exhibit a wider passband but improved attenuation in the stopband. By cascading the filters 310, 320, the advantages of the filters may be combined.

Signal B at the output of the lattice filter 310 would correspondingly show a spectrum similar to spectrum 420 but for passbands corresponding to L1, centered at about 1290 nm and L3, centered at about 1330 nm. FIR filter 330 may correspondingly show a spectrum similar to spectrum 410, but likewise with a passband center frequency corresponding to approximately 1290 nm (L1) and approximately 1330 nm (L3).

FIG. 4B illustrates exemplary transmission spectra of a CDWM demultiplexer 300. FIG. 4B shows wavelength on the x-axis and (power) transmission on the y-axis, in dB relative to an input power. There is further shown spectrum 460 corresponding to Output 1 and spectrum 450 corresponding to Output 2, as illustrated in FIG. 3

Spectrum 460 (Output 1) may be an example of the combined, cascaded filtering of filter 310 and 320, and may show an exemplary combination of the spectra 410 and 420. As may be seen from spectrum 460, the passband (e.g., for L0 carrier between about 1260 nm and 1280 nm) is narrower than that of either spectra 410 or 420, and the attenuation in the stopband (e.g., for L1, between about 1280 nm and 1300 nm) may be significantly improved over either spectra 410 or 420 alone.

The present disclosure includes reference to certain examples; however, it will be understood by those skilled in the art that various changes may be made and equivalents may be substituted without departing from the scope of the disclosure. In addition, modifications may be made to the disclosed examples without departing from the scope of the present disclosure. Therefore, it is intended that the present disclosure not be limited to the examples disclosed, but that the disclosure will include all examples falling within the scope of the appended claims.

What is claimed is:

1. An optical frequency-division demultiplexer, comprising:
a plurality of cascaded half-band filters, each of said cascaded half-band filters comprising a plurality of stages, wherein each stage comprises a waveguide, a phase shifter, and a coupler.
a first half-band filter of said plurality of cascaded half-band filters is an N-th order filter and a second half-band filter of said plurality of cascaded half-band filter is an M-th order filter, wherein N is unequal to M, and said first half-band filter and said second half-band filter have a same channel spacing.

2. The device according to claim 1, wherein said waveguide, said phase shifter and/or said coupler are tunable.

3. The device according to claim 1, wherein said optical delay, said phase shifter, and said coupler are fabricated on a planar optical waveguide circuit.

4. The device according to claim 1, wherein said demultiplexer may be adapted to coarse wavelength division multiplexing (CDWM).

5. The device according to claim 4, wherein said CDWM complies with IEEE and/or ITU standards.

6. The device according to claim 1, wherein said same channel spacing may be 20 nm, 40 nm, or 80 nm.

7. The device according to claim 1, wherein the difference between N and M is an even number.

8. The device according to claim 1, whereas the passband center frequencies of said first half-band filter and said second half-band filter are substantially the same.

9. The device according to claim 1, whereas the stopband center frequencies of said first half-band filter and said second half-band filter are substantially the same.

10. The device according to claim 1, whereas one or more minima in the stopband of said first half-band filter occur at a substantially same wavelength as one or more maxima of said second half-band filter.

11. The device according to claim 1, wherein the combined extinction ratio of said plurality of cascaded half-band filters exceeds 10 dB at a center frequency of its stopband.

12. The device according to claim 7, wherein the difference between N and M is 2.

13. The device according to claim 1, wherein said Nth-order is greater than said Mth-order.
